(19) United States
(12) Patent Application Publication
(10) Pub. No.: US 2026/0259641 A1
(43) Pub. Date: Sep. 3, 2026

(54) SHARING OF CAPTURED CONTENT

(71) Applicant: Google LLC, Mountain View, CA (US)

(72) Inventors: Michael Alexander Digman, Mountain View, CA (US); Michael Lee, San Ramon, CA (US); Saad Ansari, San Francisco, CA (US); Russell Lawrence Matsuo, San Francisco, CA (US)

(21) Appl. No.: 18/846,721

(22) PCT Filed: Mar. 30, 2023
(86) PCT No.: PCT/US2023/016997

§ 371 Date: Sep. 13, 2024

Related U.S. Application Data
(60) Provisional application No. 63/362,425, filed on Apr. 4, 2022.

(51) Int. Cl. G06F 3/0484; G06F 3/0482; G06F 9/451; G06F 40/166

(52) U.S. Cl. CPC G06F 3/0484; G06F 3/0482; G06F 9/451; G06F 40/166

(57) ABSTRACT

A computing device is described that receives a first indication of user input that corresponds to a capture action to capture content being outputted for display at a display device. The computing device may, in response to the content being captured, output, for display at the display device, a graphical user interface element that includes indications of a plurality of actions, wherein the plurality of actions include one or more of an edit action, a cross-device sharing action, a cross-application sharing action, or one or more recommended actions. The computing device may receive a second indication of user input that corresponds to selection of an action of the plurality of actions indicated by the GUI element. The computing device may, in response to receiving the second indication of user input that corresponds to selection of the action, perform the action.

### BACKGROUND

A user may interact with a computing device to capture content being displayed by a display device to move the captured content between applications and/or between computing devices. For example, the user may capture content by taking a screenshot, by copying content to one or more clipboards, or by using sharing functions provided by the operating system of the computing device.

### SUMMARY

In general, the techniques of this disclosure are directed to techniques for enabling a computing device to provide a consistent user experience for users to share captured content with applications and devices. A user of the computing device may capture content in a variety of ways, such as via copying the content or otherwise saving the content to one or more clipboards, taking a screenshot, or using a sharing action provided by the operating system of the computing device. Regardless of the way that the user captures content, the computing device may output a consistent user interface that enables the user to take action on the captured content. Specifically, the computing device may, in response to performing a capture action to capture content, output a visually consistent user interface that indicates an edit action and a sharing action to enable the user to edit the captured content and to share the captured content or edited captured content across applications and devices regardless of how the content was captured or edited by the computing device.

In some aspects, the techniques described herein relate to a method including: receiving, by one or more processors of a computing device, a first indication of user input that corresponds to a capture action to capture content; in response to the content being captured, outputting, by the one or more processors and for display at a display device, a graphical user interface (GUI) element that includes indications of a plurality of actions, wherein the plurality of actions include one or more of an edit action, a cross-device sharing action, a cross-application sharing action, or one or more recommended actions associated with the content; receiving, by the one or more processors, a second indication of user input that corresponds to selection of an action of the plurality of actions indicated by the GUI element; and in response to receiving the second indication of user input that corresponds to selection of the action, performing, by the one or more processors, the action.

In some aspects, the techniques described herein relate to a computing device including: a memory; and one or more processors configured to: receive a first indication of user input that corresponds to a capture action to capture content; in response to the content being captured, output, for display at a display device, a graphical user interface (GUI) element that includes indications of a plurality of actions, wherein the plurality of actions include one or more of an edit action, a cross-device sharing action, a cross-application sharing action, or one or more recommended actions associated with the content; receive a second indication of user input that corresponds to selection of an action of the plurality of actions indicated by the GUI element; and in response to receiving the second indication of user input that corresponds to selection of the action, perform the action.

In some aspects, the techniques described herein relate to a non-transitory computer-readable storage medium including instructions, that when executed by one or more processors, cause the one or more processors of a computing device to: receive a first indication of user input that corresponds to a capture action to capture content; in response to the content being captured, output, for display at a display device, a graphical user interface (GUI) element that includes indications of a plurality of actions, wherein the plurality of actions include one or more of an edit action, a cross-device sharing action, a cross-application sharing action, or one or more recommended actions associated with the content; receive a second indication of user input that corresponds to selection of an action of the plurality of actions indicated by the GUI element; and in response to receiving the second indication of user input that corresponds to selection of the action, perform the action.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1D are conceptual diagrams illustrating an example computing device, in accordance with one or more aspects of the present disclosure.

FIG. 2 is a block diagram illustrating further details of an example computing device, in accordance with one or more aspects of the present disclosure.

FIG. 3 is a block diagram illustrating an example computing device that outputs graphical content for display at a remote device, in accordance with one or more techniques of the present disclosure.

FIG. 4 is a flowchart illustrating example operations performed by an example computing device that is configured to perform notification management, in accordance with one or more aspects of the present disclosure.

### DETAILED DESCRIPTION

In general, the techniques of this disclosure are directed to techniques for a computing device to provide a consistent user experience for users to share captured content with applications and devices. Users of computing devices may often use computing devices to capture content in order to share such captured content with other applications and/or devices. For example, a user may use a smartphone to copy the Universal Resource Locator (URL) of a web link in order to share the web link with a friend, or may use a smartphone to send a picture from the smartphone to the user's laptop. A user of the computing device may use the computing device to capture content being displayed by a display device in a variety of ways, such as via copying the content, taking a screenshot, or using a sharing action (e.g., a share sheet) provided by the operating system of the computing device.

Users may be outcome-driven when attempting to capture and share content. That is, users may, when capturing content, be primarily concemed with sharing the captured content, and may be less concemed about the specific way in which the content to be shared is captured. As such, if a user is unable to use a specific way of capturing content to capture a particular content that the user wants to share, the user may switch to another way of capturing content to capture and share the particular content. For example, if a user is unable to copy a particular content that the user wants to share, the user may switch to taking a screenshot that includes the particular content in order to share the particular content.

Users of computing devices may therefore have the same mental model or overlapping mental models when thinking about different techniques for capturing content, such as copying, taking screenshots, and using sharing actions. That is, the users may group these different techniques together as tools for capturing and sharing content. However, if a computing device provides different user interfaces that enable users to perform different sets of actions depending on the technique used to capture content, such lack of consistency may not align with the mental models of users in grouping different techniques for capturing content together as tools for capturing and sharing content. Such lack of alignment with the mental models of users may make the different user interfaces provided by the computing device difficult to use for users of the computing device.

In accordance with aspects of the present disclosure, a computing device may, in response to performing a capture action to capture content being displayed at a display device, output a consistent user interface that enables the user to take action on the captured content regardless of how the content was captured by the computing device. That is, regardless of whether the content was captured by copying the content, by taking a screenshot, by using sharing functions provided by the operating system of the computing device, or by using any other suitable capture actions or mechanisms provided by the operating system or applications, the computing device may output such a consistent user interface that provides the ability to edit the captured content prior to sharing the captured content and the ability to share the captured content with other applications and/or devices.

The techniques of the present disclosure may provide one or more potential advantages. By enabling a computing device to output a consistent user interface that provides the ability to edit captured content prior to sharing the captured content and the ability to share captured content with other applications and/or devices regardless of how the content was captured by the computing device, the techniques of the present disclosure may improve the user interface of the computing device.

Specifically, outputting a consistent user interface that consistently enables the ability to share content with other devices and to perform recommended actions on the content in response to capturing content may increase user familiarity with the user interface outputted in response to capturing content and may enable users of the computing device to more quickly and easily perform common functions such as editing the captured content and/or sharing the captured content with other applications and devices. Increasing user familiarity with the user interface and enabling users of the computing device to more quickly and easily perform common functions such as editing the captured content and/or sharing the captured content with other applications and devices may reduce the amount of user input received by the computing device by reducing the amount of user interactions with the computing device, as the user may not have to interact with different and/or unfamiliar user interfaces presented as a result of performing different types of capture actions to capture content in order to edit and/or share the captured content. Reducing the amount of user input received by the computing device reduces the amount of processor cycles used to process user input and thereby reduces the amount of battery power consumed by the computing device, thereby providing one or more technical advantages.

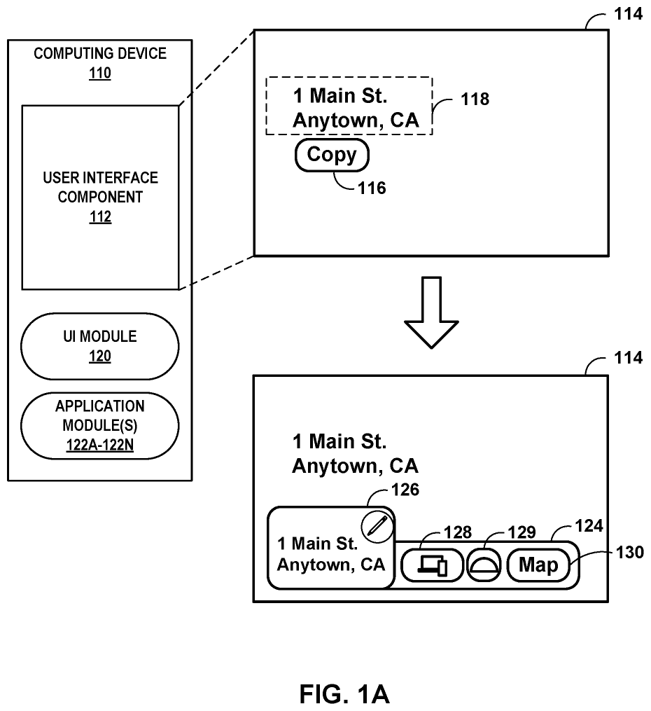

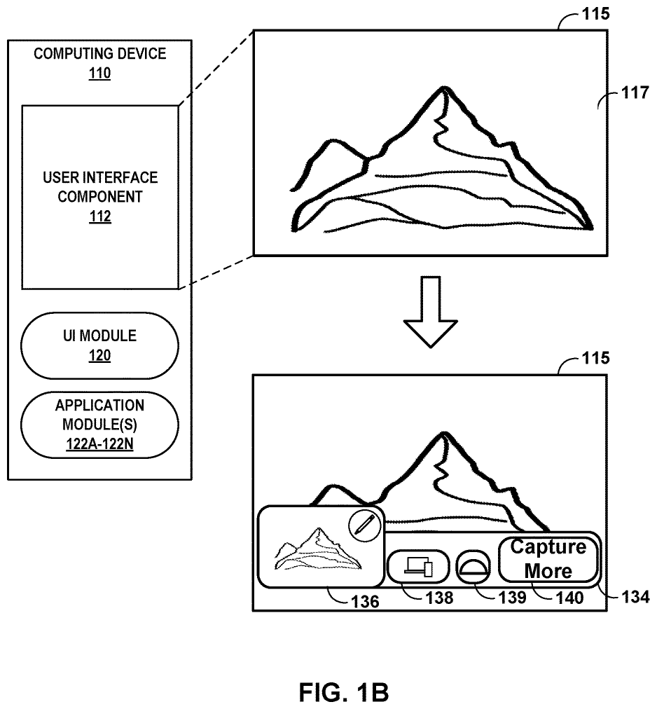

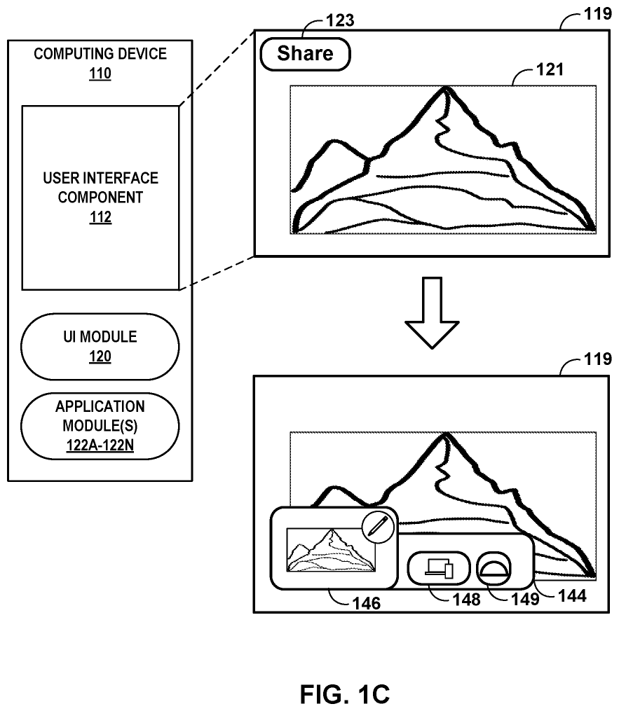

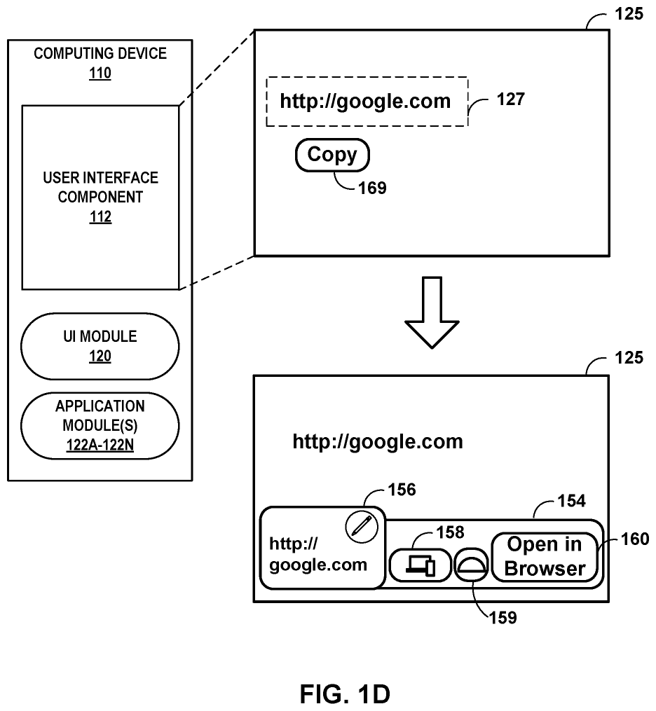

FIGS. 1A-1D are conceptual diagrams illustrating an example computing device, in accordance with one or more aspects of the present disclosure. In the example of FIG. 1A, examples of computing device 110 may include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistants (PDA), a gaming system, a media player, an e-book reader, a mobile television platform, an automobile navigation or infotainment system, or any other type of mobile, non-mobile, wearable, and/or non-wearable computing device.

Computing device 110 includes user interface component (“UIC”) 112, user interface (“UI”) module 120, and one or more application modules 122A-122N (“application modules 122”). UI module 120 and application modules 122 may perform operations described herein using software, hardware, firmware, or a mixture of hardware, software, and firmware residing in and/or executing at computing device 110. Computing device 110 may execute UI module 120 and application modules 122 with multiple processors or multiple devices, as virtual machines executing on underlying hardware, as one or more services of an operating system or computing platform, and/or as one or more executable programs at an application layer of a computing platform of computing device 110.

UIC 112 of computing device 110 may function as an input and/or output device for computing device 110. UIC 112 may be implemented using various technologies. For instance, UIC 112 may function as an input device using a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology for receiving user input. UIC 112 may also function as an input device using one or more buttons, switches, sliders, sensors, and the like. UIC 112 may function as an output device configured to present output to a user using any one or more of a liquid crystal display (LCD), dot matrix display, light emitting diode (LED) display, miniLED, microLED, organic light-emitting diode (OLED) display, e-ink, or similar monochrome or color display capable of outputting visible information to the user of computing device 110.

UIC 112 may detect input (e.g., touch and non-touch input) from a user of computing device 110. UIC 112 may detect indications of input by detecting one or more gestures performed by a user (e.g., the user touching, pointing, and/or swiping at or near one or more locations of UIC 112 with a finger or a stylus pen). UIC 112 may output information to a user in the form of a user interface, which may be associated with functionality provided by computing device 110. For example, UIC 112 may present various functions and applications executing on computing device 110 such as a web browser application, an electronic message application, a messaging application, a map application, etc.

Application modules 122 may include functionality to perform any variety of operations on computing device 110. For instance, application modules 122 may include an email application, text messaging application, instant messaging application, weather application, video conferencing application, social networking application, weather application, stock market application, emergency alert application, sports application, office productivity application, multimedia player, etc. Although shown as operable by computing device 110, one or more of application modules 122 may be operable by a remote computing device that is communicatively coupled to computing device 110. In such examples, an application module executing at a remote computing device may cause the remote computing device to send the content and intent information using any suitable form of data communication (e.g., wired or wireless network, short-range wireless communication such as Near Field Communication or Bluetooth, etc.). In some examples, a remote computing device may be a computing device that is separate from computing device 110. For instance, the remote computing device may be operatively coupled to computing device 110 by a network. Examples of a remote computing device may include, but is not limited to a server. smartphone, tablet computing device, smart watch, and desktop computer. In some examples, a remote computing device may not be an integrated component of computing device 110.

UI module 120 may be implemented in various ways. For example, UI module 120 may be implemented as a downloadable or pre-installed application or “app.” In another example, UI module 120 may be implemented as part of a hardware unit of computing device 110. In another example, UI module 120 may be implemented as part of an operating system of computing device 110. In some instances, portions of the functionality of UI module 120 or any other module described in this disclosure may be implemented across any combination of an application, hardware unit, and operating system.

UI module 120 may interpret inputs detected at UIC 112 (e.g., as a user provides one or more gestures at a location of UIC 112 at which user interface 114 or another example user interface is displayed). UI module 120 may relay information about the inputs detected at UIC 112 to one or more associated platforms, operating systems, applications, and/or services executing at computing device 110 to cause computing device 110 to perform a function. UI module 120 may also receive information and instructions from one or more associated platforms, operating systems, applications, and/or services executing at computing device 110 (e.g., application modules 122) for generating a GUI. In addition, UI module 120 may act as an intermediary between the one or more associated platforms, operating systems, applications, and/or services executing at computing device 110 and various output devices of computing device 110 (e.g., speakers, LED indicators, vibrators, etc.) to produce output (e.g., graphical, audible, tactile, etc.) with computing device 110.

In the example of FIG. 1A, one of application modules 122 may send data to UI module 120 that causes UIC 112 to generate user interface 114, and elements thereof. In response, UI module 120 may output instructions and information to UIC 112 that cause UIC 112 to display user interface 114 according to the information received from the application.

User interfaces 114 represent graphical user interfaces with which a user of computing device 110 can interact with application modules 122 of computing device 110, such as a messaging client (e.g., a text messaging client or an e-mail client), a web browser application, a word processing application, and the like. When handling input detected by UIC 112, UI module 120 may receive information from UIC 112 in response to inputs detected at locations of a screen of UIC 112 at which elements of user interface 114 are displayed. UI module 120 disseminates information about inputs detected by UIC 112 to other components of computing device 110 for interpreting the inputs and for causing computing device 110 to perform one or more functions in response to the inputs.

In accordance with aspects of the present disclosure, the user of computing device 110 may interact with computing device 110, such as by providing user input at UIC 112 to perform a capture action to capture content at computing device 110. The content that can be captured may include content being outputted by computing device 110, such as for display at UIC 112, for output by audio output components of UIC 112, and the like. Content being outputted by computing device 110 may include all or a portion of a GUI being outputted by computing device 110 for display at UIC 112, such as text (including text recognized in images and videos), graphics, animated graphics, videos, and the like, audio or sounds outputted at audio output components of UIC 112, and the like. In some examples, the content that can be captured may also include textual, audio, and or visual descriptions of content being outputted at computing device 110, such as a textual description of an image being outputted for display at UIC 112. In some examples, the content that can be captured may also include files (e.g., a word processing document), applications, or any other data stored by or accessible to computing device 110. A capture action may include copying content to one or more clipboards (i.e., a copy action), taking a screenshot of the content being outputted for display at UIC 112 (i.e., a screenshot action), invoking a sharing functionality of the operating system of computing device 110, and/or any other action for capturing content at computing device 110.

Computing device 110 may receive an indication of such a user input that corresponds to the capture action to capture content and may, in response to the content being captured, output, for display at a display device (e.g., UIC 112), a GUI element that includes indications of a plurality of actions that are associated with the captured content. Examples of such a GUI element may include one or more of: buttons, a toolbar, a menu, a list, a sheet, or another type of GUI element.

The operating system of computing device 110 may output the GUI element that includes the indications of the plurality of actions in response to the content being captured. As such, the GUI element that includes the indications of the plurality of actions in response to the content being captured may be a system-wide GUI element, and computing device 110 may output the GUI element that includes the indications of the plurality of actions in response to the content being captured regardless of the applications currently executing at computing device 110, regardless of the current foreground application executing at computing device 110, and regardless of whether the performed capture action is an operating system-provided capture action or if the performed capture action is a function provided by an application executing at computing device 110.

Computing device 110 may receive an indication of user input that corresponds to selection of an action of the plurality of actions indicated in the GUI element. Computing device 110 may, in response to receiving the indication of user input that corresponds to selection of the action, perform the selected action.

The plurality of actions indicated by the GUI element may include an edit action, a cross-device sharing action, and a cross-application sharing action. The edit action may be an action that, if selected, enables the user to provide user input to edit the captured content, and computing device 110 may save the resulting edited content to a clipboard. For example, if the captured content includes text, the edit action, if selected, enables the user to provide user input to edit the text, such as by inserting characters to the text, deleting characters from the text, and the like. In another example, if the captured content includes an image (e.g., a captured screenshot), the edit action, if selected, enables the user to provide user input to edit the captured image, such as by cropping the image, applying image filters to the captured image, and the like.

The cross-device sharing action may be an action that, if selected, enables computing device 110 to share the captured content with one or more other computing devices. That is, computing device 110 may transmit the captured content to one or more other computing devices that is communicably coupled to computing device 110, such as via a communications link (e.g., BLUETOOTH, WIFI, or any other suitable wired or wireless communications technology, the Internet, or any other communications medium). For example, the cross-device sharing action, if selected, enables the user to select another computing device, such as a computing device that is nearby computing device 110, to which computing device 110 may transmit the captured content. In another example, the cross-device sharing action, if selected, may transmit the content to a server system, such as a cloud storage platform, so that one or more other computing devices may be able to access the captured content via such a server system.

The cross-application sharing action may be an action that, if selected, enables computing device 110 to share the captured content to one or more of application modules 122 executing at computing device 110 and/or to perform one or more actions on the captured content. For example, the cross-application sharing action, if selected, enables the user to select one or more applications to which the operating system of computing device 110 may share the captured content.

In some examples, the plurality of actions indicated by the GUI element may also include one or more recommended actions associated with the captured content. Computing device 110 may determine the one or more recommended actions associated with the captured content as one or more recommended actions relevant to the captured content based on the type of capture action performed to capture the captured content (e.g., copying versus capturing a screenshot), the content type of the captured content (e.g., whether the captured content includes text, an image, a video, etc.), data patterns detected within the captured content (e.g., whether the captured content includes data, an address, a web address, a phone number, a street address, etc.), which may be determined using a text classifier, objects recognized in the captured content (e.g., people recognized via facial recognition in captured photos, text recognized within captured images), metadata of the captured content (e.g., metadata of an image in the captured content such as the location where a photo was taken, song and/or artist information of a piece of audio in the captured content), and/or any other information or context associated with the capture action and/or captured content. As such, computing device 110 may be able to determine different sets of one or more recommended actions for different captured content captured using different capture actions.

In the example of FIG. 1A, UI module 120 may output instructions and information to UIC 112 that cause UIC 112 to display user interface 114. User interface 114 outputted by UIC 12 includes content 118 that is the text “1 Main St. Anytown, CA,” which is an address. The user of computing device 110 may provide user input to perform a capture action to capture content 118 by selecting the text “1 Main St. Anytown, CA” and selecting GUI element 116 in user interface 114, which is a copy button, to copy the selected text “1 Main St. Anytown, CA” to one or more clipboards.

Computing device 110 may, in response to content 118 being copied to one or more clipboards, output, for display at UIC 112, GUI element 124 in user interface 114 that includes indications of a plurality of actions associated with the captured content 118. Specifically, GUI element 124 may include edit button 126, which is an indication of an edit action, cross-device sharing button 128, which is an indication of a cross-device sharing action, and cross-application sharing button 107, which is an indication of a cross-application sharing action.

Computing device 110 may, in response to content 118 being copied to one or more clipboards, also determine one or more recommended actions associated with the captured content 118. Computing device 110 may determine that the captured content 118 of “1 Main St. Anytown, CA” is a street address and may therefore determine that a mapping action is associated with the captured content 118 that includes the address “1 Main St. Anytown, CA.” A mapping action may be an action that, if selected, causes computing device 110 to output, for display at UIC 112, a map GUI that presents a digital map of the address included in content 118. As such, GUI element 124 may therefore also include map button 130, which is an indication of a mapping action.

The user may provide user input at UIC 112 to interact with GUI element 124 to select an action indicated in GUI element 124 to be performed. Computing device 110 may, in response to receiving an indication of user input at UIC 112 that corresponds to the selection of an action out of the plurality of actions indicated in GUI element 124, perform the selected action.

In some examples, the user may provide user input at UIC 112 to select edit button 126 to edit the captured content 118. As described above, edit button 126 is an indication of an edit action, which may be an action that, if selected, enables the user to provide user input to edit the captured content, and computing device 110 may save the resulting edited content to one or more clipboards and/or to a storage device or system (e.g., hard disk or cloud storage) of computing device 110 and/or accessible by computing device 110. As such, computing device 110 may, in response to receiving an indication of user input at UIC 112 that corresponds to selection of edit button 126, output, for display at UIC 112, an editing GUI that enables the user to edit content 118, such as by enabling the user to edit the text included in content 118. Computing device 110 may therefore save the resulting edited content 118 to a clipboard.

In some examples, the user may provide user input at UIC 112 to select cross-device sharing button 128. As described above, cross-device sharing button 128 is an indication of a cross-device sharing action, which may be an action that, if selected, enables computing device 110 to share the captured content 118 with one or more other computing devices. That is, computing device 110 may, upon selection of the cross-device sharing action, transmit the captured content 118 to one or more other computing devices that are communicably coupled to computing device 110.

Computing device 110 may, in response to receiving an indication of user input at UIC 112 that corresponds to selection of cross-device sharing button 128, perform the cross-device sharing action to share the captured content 118 with one or more other computing devices, such as by transmitting the captured content 118 to the one or more other computing devices. In some examples, to share the captured content 118 with one or more other computing devices, computing device 110 may determine one or more computing devices with which computing device 110 may share the captured content 118 via any suitable technique. For example, computing device 110 may determine one or more computing devices with which computing device 110 may share the captured content 118 as one or more computing devices that are physically proximate to computing device 110 (e.g., within wireless communications range of computing device 110), one or more computing devices that are communicably coupled to computing device 110, one or more computing devices that have enabled receiving shared content from computing device 110, one or more computing devices that computing device 110 have determined as being relevant to the captured content 118 (determined by, for example, by performing text classification, image recognition, and the like on the captured content 118), and the like.

In some examples, computing device 110, may, in response to receiving an indication of user input at UIC 112 that corresponds to selection of cross-device sharing button 128, share content 118 with one or more other computing devices without enabling the user to select the one or more computing devices with which computing device 110 shares content 118. Instead, computing device 110 may determine one or more computing devices with which computing device 110 may share the captured content 118, such as via the techniques described above, and may share content 118 by sending content 118 to each of the one or more computing devices, sending content 118 to a cloud provider system accessible by each of the one or more computing devices, and the like.

In some examples, computing device 110 may, in response to receiving an indication of user input at UIC 112 that corresponds to selection of cross-device sharing button 128, output, for display at UIC 112, a sharing GUI that enables the user to select one or more other computing devices with which to share the captured content 118. In some examples, the sharing GUI may be a share sheet provided by the operating system of computing device 110 that includes indications of one or more computing devices with which computing device 110 may share content 118. The user may provide user input at UIC 112 to select one or more of the indicated one or more computing devices in the sharing GUI, and computing device 110 may, in response to reviving an indication of user input at UIC 112 that corresponds to selection of one or more computing devices, share content 118 with the selected one or more devices, such as by sending content 118 to the selected one or more computing devices external to computing device 110 or by transmitting content 118 to a cloud storage system accessible by each of the selected one or more computing devices.

In some examples, the user may provide user input at UIC 112 to select cross-application sharing button 129. As described above, cross-application sharing button 129 is an indication of a cross-application sharing action, which may be an action that, if selected, enables computing device 110 to share the captured content 118 with one or more applications at computing device 110. That is, computing device 110 may, upon selection of the cross-application sharing action, share the captured content 118 with an application executing at computing device 110.

Computing device 110 may, in response to receiving an indication of user input at UIC 112 that corresponds to selection of cross-application sharing button 129, perform the cross-application sharing action to share the captured content 118 with one or more applications executing at computing device 110. In some examples, to share the captured content 118 with one or more applications, computing device 110 may determine one or more relevant applications at computing device 110 that may receive the captured content 118 via any suitable technique, such as by performing text classification, image recognition, and the like on the captured content 118.

In some examples, computing device 110, may, in response to receiving an indication of user input at UIC 112 that corresponds to selection of cross-application sharing button 129, share content 118 with one or more applications without enabling the user to select the one or more applications with which content 118 is shared. Instead, computing device 110 may determine one or more relevant applications with which computing device 110 may share the captured content 118, such as via the techniques described above, and may share content 118 with each of the one or more relevant applications.

In some examples, computing device 110 may, in response to receiving an indication of user input at UIC 112 that corresponds to selection of cross-application sharing button 129, output, for display at UIC 112, a sharing GUI that enables the user to select one or more applications with which to share the captured content 118. In some examples, the sharing GUI may be a share sheet provided by the operating system of computing device 110 that includes indications of one or more applications with which computing device 110 may share content 118. The user may provide user input at UIC 112 to select one or more of the indicated one or more applications in the sharing GUI, and computing device 110 may, in response to reviving an indication of user input at UIC 112 that corresponds to selection of one or more applications, share content 118 with each of the one or more indicated applications.

In some examples, the user may provide user input at UIC 112 to select map button 130. As described above, map button 130 is an indication of a mapping action, which may be an action that, if selected, causes computing device 110 to output, for display at UIC 112, a map GUI that presents a digital map of the address included in content 118. As such, computing device 110 may, in response to receiving an indication of user input at UIC 112 that corresponds to selection of map button 130, output, for display at UIC 112, a map GUI that presents a digital map of the address included in content 118.

In some examples, computing device 110 may, regardless of the performed capture action and regardless of the captured content, output a GUI element that includes at least an indication of a cross-device sharing action and an indication of an edit action. Computing device 110 may therefore, in response to performance of a capture action, consistently output a GUI element with which a user may interact to edit and share the captured content. Consistently outputting a GUI element that includes at least an indication of a cross-device sharing action and an indication of an edit action in response to the performance of different capture captions and/or capturing different types of content may enable the user to more quickly and simply interact with computing device 110 to edit and share captured content, and may align the user's intended actions with the user's mental model of sharing such captured content.

The GUI element outputted by computing device 110 in response to content being captured may be visually consistent with each other regardless of the type of capture action performed to capture the content. That is, the GUI element outputted by computing device 110 in response to content being captured may be visually consistent regardless of whether content was captured by copying, taking a screenshot, using a sharing function, etc.

In some examples, GUI elements may be visually consistent if they are about the same size, use the same colors, use the same fonts, and the like. In some examples, GUI elements may be visually consistent if they are of the same GUI element type. As described above, different examples of GUI element types may include buttons, menus, fields, menu bars, button bars, toolbars, lists, sheets, etc. As such, in some examples, every GUI element outputted by computing device 110 in response to content being captured may be of the same GUI element type, such as each being a button bar that includes a set of buttons. In some examples, GUI elements may also be visually consistent if they are displayed at the same positions or at consistent positions in a user interface (e.g. user interface 114), such as by being displayed at the bottom left of the user interface outputted by computing device 110 for display at the display device.

In some examples, GUI elements outputted by computing device 110 in response to content being captured may be visually consistent by indicating actions (e.g., the edit action, the cross-device sharing action, and the cross-application sharing button) using the same GUI element type across different GUI elements, thereby providing standardized visual feedback to the user. For example, each GUI element outputted by computing device 110 in response to content being captured may indicate the edit action using the same GUI element type, such as a button. Similarly, each GUI element outputted by computing device 110 in response to content being captured may indicate the cross-device sharing action using the same GUI element type, such as a button.

In some examples, GUI elements outputted by computing device 110 in response to content being captured may be visually consistent by placing indications of actions in the same position and/or order in each of the GUI elements. For example, each GUI element outputted by computing device 110 in response to content being captured may position an indication of the edit action (e.g., edit button 126) before an indication of the cross-device sharing action (e.g., cross-device sharing button 128), such as by placing the indication of the edit action to the left of the indication of the cross-device sharing action, by placing the indication of the edit action above the indication of the cross-device sharing action, and the like.

As shown in FIG. 1B, one of application modules 122 may send data to UI module 120 that causes UIC 112 to generate user interface 115, and elements thereof. In response, UI module 120 may output instructions and information to UIC 112 that cause UIC 112 to display user interface 115 according to the information received from the application.

User interfaces 115 represent graphical user interfaces with which a user of computing device 110 can interact with application modules 122 of computing device 110, such as a messaging client (e.g., a text messaging client or an e-mail client), a web browser application, a word processing application, and the like. When handling input detected by UIC 112, UI module 120 may receive information from UIC 112 in response to inputs detected at locations of a screen of UIC 112 at which elements of user interface 115 are displayed. UI module 120 disseminates information about inputs detected by UIC 112 to other components of computing device 110 for interpreting the inputs and for causing computing device 110 to perform one or more functions in response to the inputs.

In the example of FIG. 1B, UI module 120 may output instructions and information to UIC 112 that cause UIC 112 to display user interface 115. The user of computing device 110 may provide user input to perform a capture action to capture a screenshot of user interface 115, thereby capturing the screenshot of user interface 115 as content 117.

Computing device 110 may, in response to capturing the screenshot of user interface 115 as content 117, save the captured content 117 in one or more clipboards and may output, for display at UIC 112, GUI element 134 in user interface 115 that includes indications of a plurality of actions associated with the captured content 117. Specifically, GUI element 134 may include edit button 136, which is an indication of an edit action, cross-device sharing button 138, which is an indication of a cross-device sharing action, and cross-application sharing button 139, which is an indication of a cross-application sharing action.

Computing device 110 may, in response to content 117 being captured, also determine one or more recommended actions associated with the captured content 117. Computing device 110 may determine that the captured content 117 is a screenshot and may therefore determine that a capture more action is associated with the captured content 117. A capture more action may be an action that, if selected, causes computing device 110 to output, for display at UIC 112, a GUI that may enable the user to capture additional content in user interface 115. As such, GUI element 134 may therefore also include capture more button 140, which is an indication of a capture more action.

The user may provide user input at UIC 112 to interact with GUI element 134 to select an action indicated in GUI element 134 to be performed. Computing device 110 may, in response to receiving an indication of user input at UIC 112 that corresponds to the selection of an action out of the plurality of actions indicated in GUI element 134, perform the selected action.

In some examples, the user may provide user input at UIC 112 to select edit button 136 to edit the captured content 117. As described above, edit button 136 is an indication of an edit action, which may be an action that, if selected, enables the user to provide user input to edit the captured content, and computing device 110 may save the resulting edited content to a clipboard. As such, computing device 110 may, in response to receiving an indication of user input at UIC 112 that corresponds to selection of edit button 136, output, for display at UIC 112, an editing GUI that enables the user to edit content 117, such as by enabling the user to crop the screenshot in content 117, apply filters to the screenshot in content 117, drawing on content 117, and the like. Computing device 110 may therefore save the edited content 117 to the clipboard.

In some examples, the user may provide user input at UIC 112 to select cross-device sharing button 138. As described above, cross-device sharing button 138 is an indication of a cross-device sharing action, which may be an action that, if selected, enables computing device 110 to share the captured content 117 with another computing device. That is, computing device 110 may, upon selection of the cross-device sharing action, transmit the captured content 117 to one or more other computing devices that are communicably coupled to computing device 110.

Computing device 110 may, in response to receiving an indication of user input at UIC 112 that corresponds to selection of cross-device sharing button 138, perform the cross-device sharing action to share the captured content 117 with one or more other computing devices, such as by transmitting the captured content 117 to the one or more other computing devices. In some examples, to share the captured content 117 with one or more other computing devices, computing device 110 may determine one or more computing devices with which computing device 110 may share the captured content 117 via any suitable technique, such as described above with respect to FIG. 1A

In some examples, computing device 110, may, in response to receiving an indication of user input at UIC 112 that corresponds to selection of cross-device sharing button 138, share content 117 with one or more other computing devices without enabling the user to select the one or more computing devices with which computing device 110 shares content 117. Instead, computing device 110 may determine one or more computing devices with which computing device 110 may share the captured content 117, such as via the techniques described above, and may share content 117 by sending content 117 to each of the one or more computing devices, sending content 117 to a cloud provider system accessible by each of the one or more computing devices, and the like.

In some examples, computing device 110 may, in response to receiving an indication of user input at UIC 112 that corresponds to selection of cross-device sharing button 138, output, for display at UIC 112, a sharing GUI that enables the user to select one or more other computing devices with which to share the captured content 117. In some examples, the sharing GUI may be a share sheet that includes indications of one or more computing devices with which computing device 110 may share content 117. The user may provide user input at UIC 112 to select one or more of the indicated one or more computing devices in the sharing GUI, and computing device 110 may, in response to reviving an indication of user input at UIC 112 that corresponds to selection of one or more computing devices, share content 117 with the selected one or more devices, such as by sending content 117 to the selected one or more devices or by transmitting content 117 to a cloud storage system accessible by each of the selected one or more computing devices.

In some examples, the user may provide user input at UIC 112 to select cross-application sharing button 139. As described above, cross-application sharing button 139 is an indication of a cross-application sharing action, which may be an action that, if selected, enables computing device 110 to share the captured content 117 with one or more applications at computing device 110. That is, computing device 110 may, upon selection of the cross-application sharing action, share the captured content 117 with an application executing at computing device 110.

Computing device 110 may, in response to receiving an indication of user input at UIC 112 that corresponds to selection of cross-application sharing button 139, perform the cross-application sharing action to share the captured content 117 with one or more applications executing at computing device 110. In some examples, to share the captured content 117 with one or more applications, computing device 110 may determine one or more relevant applications at computing device 110 that may receive the captured content 117 via any suitable technique, such as by performing text classification, image recognition, and the like on the captured content 117.

In some examples, computing device 110, may, in response to receiving an indication of user input at UIC 112 that corresponds to selection of cross-application sharing button 139, share content 117 with one or more applications without enabling the user to select the one or more applications with which content 117 is shared. Instead, computing device 110 may determine one or more relevant applications with which computing device 110 may share the captured content 117, such as via the techniques described above, and may share content 117 with each of the one or more relevant applications.

In some examples, computing device 110 may, in response to receiving an indication of user input at UIC 112 that corresponds to selection of cross-application sharing button 139, output, for display at UIC 112, a sharing GUI that enables the user to select one or more applications with which to share the captured content 117. In some examples, the sharing GUI may be a share sheet provided by the operating system of computing device 110 that includes indications of one or more applications with which computing device 110 may share content 117. The user may provide user input at UIC 112 to select one or more of the indicated one or more applications in the sharing GUI, and computing device 110 may, in response to reviving an indication of user input at UIC 112 that corresponds to selection of one or more applications, share content 117 with each of the one or more indicated applications.

In some examples, the user may provide user input at UIC 112 to select capture more button 140. As described above, capture more button 140 is an indication of a capture more action, which may be an action that, if selected, causes computing device 110 to output, for display at UIC 112, a GUI that may enable the user to capture additional content. That is, computing device 110 may, upon selection of capture more action, enable the user to capture additional content such as text, images, videos, audio, etc.

As shown in FIG. 1C, one of application modules 122 may send data to UI module 120 that causes UIC 112 to generate user interface 119, and elements thereof. In response, UI module 120 may output instructions and information to UIC 112 that cause UIC 112 to display user interface 119 according to the information received from the application.

User interfaces 119 represent graphical user interfaces with which a user of computing device 110 can interact with application modules 122 of computing device 110, such as a messaging client (e.g., a text messaging client or an e-mail client), a web browser application, a word processing application, and the like. When handling input detected by UIC 112, UI module 120 may receive information from UIC 112 in response to inputs detected at locations of a screen of UIC 112 at which elements of user interface 119 are displayed. UI module 120 disseminates information about inputs detected by UIC 112 to other components of computing device 110 for interpreting the inputs and for causing computing device 110 to perform one or more functions in response to the inputs.

In the example of FIG. 1C, UI module 120 may output instructions and information to UIC 112 that cause UIC 112 to display user interface 119. User interface 119 outputted by UIC 12 includes content 121 that is an image. The user of computing device 110 may provide user input to perform a capture action to capture content 121 by selecting content 121 and selecting GUI element 123 in user interface 119, which is a share button, to invoke a sharing function provided by the operating system of computing device 110.

Computing device 110 may, in response to capturing content 121 by invoking a sharing function provided by the operating system, save the captured content 121 in one or more clipboards and/or to a storage device, and may output, for display at VIC 112, GUI element 144 in user interface 119 that includes indications of a plurality of actions associated with the captured content 121. Specifically, GUI element 144 may include edit button 146, which is an indication of an edit action, cross-device sharing button 148, which is an indication of a cross-device sharing action, and cross-application sharing button 149, which is an indication of a cross-application sharing action. In the example of FIG. 1C, GUI element 144 may not include an indication of one or more one or more recommended actions associated with the captured content 121 besides edit button 146 and cross-device sharing button 148.

The user may provide user input at UIC 112 to interact with GUI element 144 to select an action indicated in GUI element 144 to be performed. Computing device 110 may, in response to receiving an indication of user input at UIC 112 that corresponds to the selection of an action out of the plurality of actions indicated in GUI element 144, perform the selected action.

In some examples, the user may provide user input at UIC 112 to select edit button 146 to edit the captured content 121. As described above, edit button 146 is an indication of an edit action, which may be an action that, if selected, enables the user to provide user input to edit the captured content 121, and computing device 110 may save the resulting edited content 121 to one or more clipboards. As such, computing device 110 may, in response to receiving an indication of user input at UIC 112 that corresponds to selection of edit button 146, output, for display at UIC 112, an editing GUI that enables the user to edit content 121, such as by enabling the user to crop the image in content 121, apply filters to the image in content 121, drawing on the image in content 121, and the like. Computing device 110 may therefore save the edited content 121 to the clipboard.

In some examples, the user may provide user input at UIC 112 to select cross-device sharing button 148. As described above, cross-device sharing button 148 is an indication of a cross-device sharing action, which may be an action that, if selected, enables computing device 110 to share the captured content 121 with another computing device. That is, computing device 110 may, upon selection of the cross-device sharing action, transmit the captured content 121 to one or more other computing devices that are communicably coupled to computing device 110.

Computing device 110 may, in response to receiving an indication of user input at UIC 112 that corresponds to selection of cross-device sharing button 148, perform the cross-device sharing action to share the captured content 121 with one or more other computing devices, such as by transmitting the captured content 121 to the one or more other computing devices. Computing device 110 may determine one or more computing devices with which computing device 110 may share the captured content 121 via any suitable technique, such as described above with respect to FIG. 1A.

In some examples, computing device 110, may, in response to receiving an indication of user input at UIC 112 that corresponds to selection of cross-device sharing button 148, share content 121 with one or more other computing devices without enabling the user to select the one or more computing devices with which computing device 110 shares content 121. Instead, computing device 110 may determine one or more computing devices with which computing device 110 may share the captured content 121, such as via the techniques described above, and may share content 121 by sending content 121 to each of the one or more computing devices, sending content 121 to a cloud provider system accessible by each of the one or more computing devices, and the like.

In some examples, computing device 110 may, in response to receiving an indication of user input at UIC 112 that corresponds to selection of cross-device sharing button 148, output, for display at UIC 112, a sharing GUI that enables the user to select one or more other computing devices with which to share the captured content 121. In some examples, the sharing GUI may be a share sheet that includes indications of one or more computing devices with which computing device 110 may share content 121. The user may provide user input at UIC 112 to select one or more of the indicated one or more computing devices in the sharing GUI, and computing device 110 may, in response to reviving an indication of user input at UIC 112 that corresponds to selection of one or more computing devices, share content 121 with the selected one or more devices, such as by sending content 121 to the selected one or more devices or by transmitting content 121 to a cloud storage system accessible by each of the selected one or more computing devices.

In some examples, the user may provide user input at UIC 112 to select cross-application sharing button 149. As described above, cross-application sharing button 149 is an indication of a cross-application sharing action, which may be an action that, if selected, enables computing device 110 to share the captured content 121 with one or more applications at computing device 110. That is, computing device 110 may, upon selection of the cross-application sharing action, share the captured content 121 with an application executing at computing device 110.

Computing device 110 may, in response to receiving an indication of user input at UIC 112 that corresponds to selection of cross-application sharing button 149, perform the cross-application sharing action to share the captured content 121 with one or more applications executing at computing device 110. In some examples, to share the captured content 121 with one or more applications, computing device 110 may determine one or more relevant applications at computing device 110 that may receive the captured content 121 via any suitable technique, such as by performing text classification, image recognition, and the like on the captured content 121.

In some examples, computing device 110, may, in response to receiving an indication of user input at UIC 112 that corresponds to selection of cross-application sharing button 149, share content 121 with one or more applications without enabling the user to select the one or more applications with which content 121 is shared. Instead, computing device 110 may determine one or more relevant applications with which computing device 110 may share the captured content 121, such as via the techniques described above, and may share content 121 with each of the one or more relevant applications.

In some examples, computing device 110 may, in response to receiving an indication of user input at UIC 112 that corresponds to selection of cross-application sharing button 149, output, for display at UIC 112, a sharing GUI that enables the user to select one or more applications with which to share the captured content 121. In some examples, the sharing GUI may be a share sheet provided by the operating system of computing device 110 that includes indications of one or more applications with which computing device 110 may share content 121. The user may provide user input at UIC 112 to select one or more of the indicated one or more applications in the sharing GUI, and computing device 110 may, in response to reviving an indication of user input at UIC 112 that corresponds to selection of one or more applications, share content 121 with each of the one or more indicated applications.

As shown in FIG. 1D, one of application modules 122 may send data to UI module 120 that causes UIC 112 to generate user interface 125, and elements thereof. In response, UI module 120 may output instructions and information to UIC 112 that cause UIC 112 to display user interface 125 according to the information received from the application.

User interfaces 125 represent graphical user interfaces with which a user of computing device 110 can interact with application modules 122 of computing device 110, such as a messaging client (e.g., a text messaging client or an e-mail client), a web browser application, a word processing application, and the like. When handling input detected by UIC 112, UI module 120 may receive information from UIC 112 in response to inputs detected at locations of a screen of UIC 112 at which elements of user interface 125 are displayed. UI module 120 disseminates information about inputs detected by UIC 112 to other components of computing device 110 for interpreting the inputs and for causing computing device 110 to perform one or more functions in response to the inputs.

In the example of FIG. 1D, UI module 120 may output instructions and information to UIC 112 that cause UIC 112 to display user interface 125. User interface 125 outputted by UIC 12 includes content 127 that is text. Specifically, content 127 is a web link with the URL “http://www.google.com”. The user of computing device 110 may provide user input to perform a capture action to capture content 127 by selecting content 127 and selecting GUI element 169 in user interface 119, which is a copy button, to copy content 127 to a clipboard.

Computing device 110 may, in response to capturing content 127 by copying content 127, such as to one or more clipboards, output, for display at UIC 112, GUI element 154 in user interface 125 that includes indications of a plurality of actions associated with the captured content 127. Specifically, GUI element 154 may include edit button 156, which is an indication of an edit action, cross-device sharing button 158, which is an indication of a cross-device sharing action, and cross-application sharing button 159, which is an indication of a cross-application sharing action.

Computing device 110 may, in response to content 127 being copied to the clipboard, also determine one or more recommended actions associated with the captured content 127. Computing device 110 may determine that the captured content 127 of “http://www.google.com” is a URL and that the URL in content 127 was not captured from a web browser application. Computing device 110 may therefore determine that a web browsing action is associated with the captured content 127 that is a URL, A web browsing action may be an action that, if selected, causes computing device 110 to open the URL of captured content 127 in a web browser application. As such, GUI element 124 may therefore also include web browser button 160, which is an indication of a web browsing action. In some examples, if computing device 110 determines that the URL in content 127 was captured from a web browser application, computing device 110 may refrain from including an indication of the web browsing action in GUI element 154, as it may be redundant to open the URL in captured content 127 in a web browser application.

The user may provide user input at UIC 112 to interact with GUI element 154 to select an action indicated in GUI element 154 to be performed. Computing device 110 may, in response to receiving an indication of user input at UIC 112 that corresponds to the selection of an action out of the plurality of actions indicated in GUI element 154, perform the selected action

In some examples, the user may provide user input at UIC 112 to select edit button 156 to edit the captured content 127. As described above, edit button 156 is an indication of an edit action, which may be an action that, if selected, enables the user to provide user input to edit the captured content 127, and computing device 110 may save the resulting edited content 127 to one or more clipboards. As such, computing device 110 may, in response to receiving an indication of user input at UIC 112 that corresponds to selection of edit button 156, output, for display at UIC 112, an editing GUI that enables the user to edit content 127, such as by enabling the user to add characters to the text of content 127, delete characters from content 127, or to otherwise edit the text of content 127. Computing device 110 may therefore save the edited content 127 to the clipboard.

In some examples, the user may provide user input at UIC 112 to select cross-device sharing button 158. As described above, cross-device sharing button 158 is an indication of a cross-device sharing action, which may be an action that, if selected, enables computing device 110 to share the captured content 127 with one or more other computing devices. That is, computing device 110 may, upon selection of the cross-device sharing action, transmit the captured content 127 to one or more other computing devices that are communicably coupled to computing device 110.

In some examples, computing device 110 may, in response to receiving an indication of user input at UIC 112 that corresponds to selection of cross-device sharing button 158, perform the cross-device sharing action share the captured content 127 with one or more other computing devices, such as by transmitting the captured content 127 to the one or more other computing devices. Computing device 110 may determine one or more computing with which computing device 110 may share the captured content 127 via any suitable technique, such as described above with respect to FIG. 1A.

In some examples, computing device 110, may, in response to receiving an indication of user input at UIC 112 that corresponds to selection of cross-device sharing button 158, share content 127 with one or more other computing devices without enabling the user to select the one or more computing devices with which computing device 110 shares content 127. Instead, computing device 110 may determine one or more computing devices with which computing device 110 may share the captured content 127, such as via the techniques described above, and may share content 127 by sending content 127 to each of the one or more computing devices, sending content 127 to a cloud provider system accessible by each of the one or more computing devices, and the like.

In some examples, computing device 110, in response to receiving an indication of user input at UIC 112 that corresponds to selection of cross-device sharing button 158, output, for display at UIC 112, a sharing GUI that enables the user to select one or more other computing devices with which to share captured content 127. In some examples, the sharing GUI may be a share sheet that includes indications of one or more computing devices with which computing device 110 may share content 127. The user may provide user input at UIC 112 to select one or more of the indicated one or more computing devices in the sharing GUI, and computing device 110 may, in response to reviving an indication of user input at UIC 112 that corresponds to selection of one or more computing devices, share content 127 with the selected one or more devices, such as by sending content 127 to the selected one or more devices or by transmitting content 127 to a cloud storage system accessible by each of the selected one or more computing devices.

In some examples, the user may provide user input at UIC 112 to select cross-application sharing button 159. As described above, cross-application sharing button 159 is an indication of a cross-application sharing action, which may be an action that, if selected, enables computing device 110 to share the captured content 127 with one or more applications at computing device 110. That is, computing device 110 may, upon selection of the cross-application sharing action, share the captured content 127 with an application executing at computing device 110.

Computing device 110 may, in response to receiving an indication of user input at UIC 112 that corresponds to selection of cross-application sharing button 159, perform the cross-application sharing action to share the captured content 127 with one or more applications executing at computing device 110. In some examples, to share the captured content 127 with one or more applications, computing device 110 may determine one or more relevant applications at computing device 110 that may receive the captured content 127 via any suitable technique, such as by performing text classification, image recognition, and the like on the captured content 127.

In some examples, computing device 110, may, in response to receiving an indication of user input at UIC 112 that corresponds to selection of cross-application sharing button 159, share content 127 with one or more applications without enabling the user to select the one or more applications with which content 127 is shared. Instead, computing device 110 may determine one or more relevant applications with which computing device 110 may share the captured content 127, such as via the techniques described above, and may share content 127 with each of the one or more relevant applications.

In some examples, computing device 110 may, in response to receiving an indication of user input at UIC 112 that corresponds to selection of cross-application sharing button 159, output, for display at UIC 112, a sharing GUI that enables the user to select one or more applications with which to share the captured content 127. In some examples, the sharing GUI may be a share sheet provided by the operating system of computing device 110 that includes indications of one or more applications with which computing device 110 may share content 127. The user may provide user input at UIC 112 to select one or more of the indicated one or more applications in the sharing GUI, and computing device 110 may, in response to reviving an indication of user input at UIC 112 that corresponds to selection of one or more applications, share content 127 with each of the one or more indicated applications.

In some examples, the user may provide user input at UIC 112 to select web browser button 160. As described above, web browser button 160 is an indication of a web browsing action, which may be an action that, if selected, causes computing device 110 to open the URL in content 127 in a web browser application. As such, computing device 110 may, in response to receiving an indication of user input at UIC 112 that corresponds to selection of web browser button 160, to open the URL in content 127 in a web browser application.

As can be seen in FIGS. 1A-1D, GUI elements 124, 134, 144, and 154 outputted by computing device 110 in response to content being captured may be visually consistent with each other regardless of the type of capture action performed to capture the content. For example, each of GUI elements 124, 134, 144, and 154 is a button bar that includes a set of buttons. Further, each of GUI elements 124, 134, 144, and 154 include each of an indication of an edit action, a cross-device sharing action, and a cross-application sharing action. The indications of the edit action, the cross-device sharing action, and the cross-application sharing action in each of GUI elements 124, 134, 144, and 154 are each of the same GUI element type (e.g., buttons). Furthermore, each of GUI elements 124, 134, 144, and 154 positions an indication of the edit action, an indication of the cross-device sharing action, and an indication of the cross-application sharing action in the same place across GUI elements 124, 134, 144, and 154.

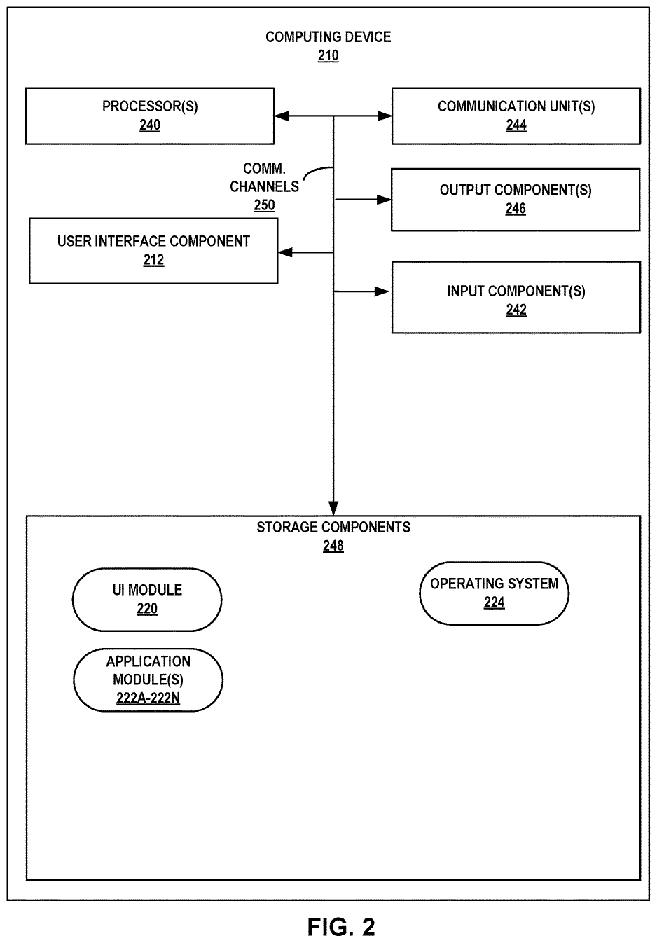

FIG. 2 is a block diagram illustrating further details of a computing device 210, in accordance with one or more aspects of the present disclosure. Computing device 210 of FIG. 2 is described below as an example of computing device 110 illustrated in FIGS. 1A-1D.

FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes UIC 212, one or more processors 240, one or more input components 242, one or more communication units 244, one or more output components 246, and one or more storage components 248. Storage components 248 of computing device 210 also include UI module 220, operating system 224, and one or more application modules 222A-222N (“one or more application modules 222”).

Communication channels 250 may interconnect each of the components 240, 212, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing device 210 may receive input. Examples of input are tactile, audio, and video input. Input components 242 of computing device 210, in one example, includes a presence-sensitive display, touch-sensitive screen, mouse, keyboard, voice responsive system, video camera, microphone or any other type of device for detecting input from a human or machine.

One or more output components 246 of computing device 210 may generate output. Examples of output are tactile, audio, and video output. Output components 246 of computing device 210, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 244 of computing device 210 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 212 of computing device 200 may be hardware that functions as an input and/or output device for computing device 210. For example, UIC 212 may include a display component, which may be a screen at which information is displayed by UIC 212 and a presence-sensitive input component that may detect an object at and/or near the display component.

One or more processors 240 may implement functionality and/or execute instructions within computing device 210. For example, one or more processors 240 on computing device 210 may receive and execute instructions stored by storage components 248 that execute the functionality of operating system 224 and modules 220 and 222. The instructions executed by one or more processors 240 may cause computing device 210 to store information within storage components 248 during program execution. Examples of one or more processors 240 include application processors, display controllers, sensor hubs, and any other hardware configured to function as a processing unit. One or more processors 240 may execute instructions of operating system 224 and modules 220 and 222 to cause UIC 212 to render portions of content of display data as one of user interface screenshots at UIC 212. That is, operating system 224 and modules 220 and 222 may be operable by one or more processors 240 to perform various actions or functions of computing device 210, such as the actions or functions described in FIGS. 1A-1D with respect to computing device 110.

One or more storage components 248 within computing device 210 may store information for processing during operation of computing device 210. That is, computing device 210 may store data accessed by operating system 224 and modules 220 and 222 during execution at computing device 210. In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with operating system 224 and modules 220 and 222. UI module 220, operating system 224, and one or more application modules 222 may execute at one or more processors 240 to perform functions similar to that of UI module 120 and one or more application modules 122, respectively, of FIGS. 1A-1D.

One or more processors 240 is configured to execute instructions stored in storage components 248 to perform the techniques of this disclosure, such as the techniques described with respect to FIGS. 1A-1D. For example, one or more processors 240 may be configured to execute instructions stored in storage components 248 to receive a first indication of user input (e.g., at one or more input components 242) that corresponds to a capture action to capture content (e.g., content outputted at one or more output components 246). One or more processors 240 may be configured to execute instructions stored in storage components 248 to, in response to the content being captured, output, for display at a display device, a graphical user interface (GUI) element that includes indications of a plurality of actions, wherein the plurality of actions include one or more of an edit action, a cross-device sharing action, a cross-application sharing action, or one or more recommended actions associated with the content. In some examples, one or more processors 240 may be configured to execute instructions of operating system 224 to output the GUI element, so that operating system 224 may be able to output such a GUI element in response to performance of a capture action to capture content across applications and services of computing device 210. That is, the GUI element may be an operating system-level GUI element rather than an application-specific GUI element outputted by, for example, a foreground application being executed by one or more processors 240.

One or more processors 240 may be configured to execute instructions stored in storage components 248 to receive a second indication of user input that corresponds to selection of an action of the plurality of actions indicated by the GUI element. One or more processors 240 may be configured to execute instructions stored in storage components 248 to, in response to receiving the second indication of user input that corresponds to selection of the action, perform the action.

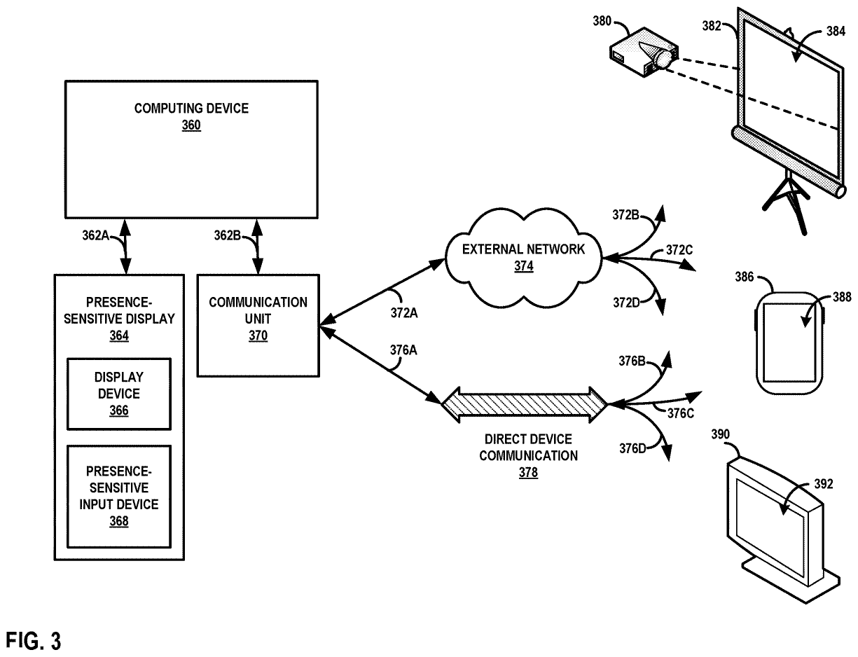

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, to name only a few examples. The example shown in FIG. 3 includes a computing device 360, a presence-sensitive display 364, communication unit 370, projector 380, projector screen 382, mobile device 386, and visual display device 390. In some examples, presence-sensitive display 364 may be a presence-sensitive display of a user interface component as described in FIGS. 1-2, such as UIC 112 of FIGS. 1A-1D and UIC of FIG. 2. Although shown for purposes of example in FIGS. 1A-1D as a stand-alone computing device 110 and in FIG. 2 as a stand-alone computing device 210, a computing device such as computing device 360 may, generally, be any component or system that includes a processor or other suitable computing environment for executing software instructions and, for example, need not include a presence-sensitive display.

As shown in the example of FIG. 3, computing device 360 may be an example of computing device 110 of FIGS. 1A-1D and/or an example of computing device 210 of FIG. 2, and may include a processor that includes functionality as described with respect to one or more processors 240 in FIG. 2. In such examples, computing device 360 may be operatively coupled to presence-sensitive display 364 by a communication channel 362A, which may be a system bus or other suitable connection. Computing device 360 may also be operatively coupled to communication unit 370, further described below, by a communication channel 362B, which may also be a system bus or other suitable connection. Although shown separately as an example in FIG. 3, computing device 360 may be operatively coupled to presence-sensitive display 364 and communication unit 370 by any number of one or more communication channels.

In other examples, such as illustrated previously by computing device 2 in FIGS. 1-2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

Presence-sensitive display 364, may include display device 366 and presence-sensitive input device 368. Display device 366 may, for example, receive data from computing device 360 and display the graphical content. In some examples, presence-sensitive input device 368 may determine one or more user inputs (e.g., continuous gestures, multi-touch gestures, single-touch gestures) at presence-sensitive display 364 using capacitive, inductive, and/or optical recognition techniques and send indications of such user input to computing device 360 using communication channel 362A. In some examples, presence-sensitive input device 368 may be physically positioned on top of display device 366 such that, when a user positions an input unit over a graphical element displayed by display device 366, the location at which presence-sensitive input device 368 corresponds to the location of display device 366 at which the graphical element is displayed.

As shown in FIG. 3, computing device 360 may also include and/or be operatively coupled with communication unit 370. Communication unit 370 may include functionality of communication unit 244 as described in FIG. 2. Examples of communication unit 370 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 360 may also include and/or be operatively coupled with one or more other devices (e.g., input devices, output devices, memory, storage devices) that are not shown in FIG. 3 for purposes of brevity and illustration.

FIG. 3 also illustrates a projector 380 and projector screen 382. Other such examples of projection devices may include electronic whiteboards, holographic display devices, and any other suitable devices for displaying graphical content. Projector 380 and projector screen 382 may include one or more communication units that enable the respective devices to communicate with computing device 360. In some examples, the one or more communication units may enable communication between projector 380 and projector screen 382. Projector 380 may receive data from computing device 360 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 360. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 384 and/or 364 as described in this disclosure. In some examples, presence-sensitive display 384 may include additional functionality. Projector screen 382 (e.g., an electronic whiteboard), may receive data from computing device 360 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 360.

FIG. 3 also illustrates mobile device 386 and visual display device 390. Mobile device 386 and visual display device 390 may each include computing and connectivity capabilities. Examples of mobile device 386 may include e-reader devices, convertible notebook devices, hybrid slate devices, etc. Examples of visual display device 390 may include other semi-stationary devices such as televisions, computer monitors, etc. As shown in FIG. 3, mobile device 386 may include a presence-sensitive display 388. Visual display device 390 may include a presence-sensitive display 392. Presence-sensitive displays 388, 392 may include a subset of functionality or all of the functionality of presence-sensitive display 384 and/or 364 as described in this disclosure. In some examples, presence-sensitive displays 388, 392 may include additional functionality. In any case, presence-sensitive display 392, for example, may receive data from computing device 360 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 360.

As described above, in some examples, computing device 360 may output graphical content for display at presence-sensitive display 364 that is coupled to computing device 360 by a system bus or other suitable communication channel. Computing device 360 may also output graphical content for display at one or more remote devices, such as projector 380, projector screen 382, mobile device 386, and visual display device 390. For instance, computing device 360 may execute one or more instructions to generate and/or modify graphical content in accordance with techniques of the present disclosure. Computing device 360 may output the data that includes the graphical content to a communication unit of computing device 360, such as communication unit 370. Communication unit 370 may send the data to one or more of the remote devices, such as projector 380, projector screen 382, mobile device 386, and/or visual display device 390. In this way, computing device 360 may output the graphical content for display at one or more of the remote devices. In some examples, one or more of the remote devices may output the graphical content at a presence-sensitive display that is included in and/or operatively coupled to the respective remote devices.

In some examples, computing device 360 may not output graphical content at presence-sensitive display 364 that is operatively coupled to computing device 360. In other examples, computing device 360 may output graphical content for display at both a presence-sensitive display 364 that is coupled to computing device 360 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 360 and output for display at presence-sensitive display 364 may be different from graphical content display output for display at one or more remote devices.

Computing device 360 may send and receive data using any suitable communication techniques. For example, computing device 360 may be operatively coupled to external network 374 using network link 372A. Each of the remote devices illustrated in FIG. 3 may be operatively coupled to external network 374 by one of respective network links 372B, 372C, or 372D. External network 374 may include network hubs, network switches, network routers, etc., that are operatively inter-coupled thereby providing for the exchange of information between computing device 360 and the remote devices illustrated in FIG. 3. In some examples, network links 372A-372D may be Ethernet, ATM or other network connections. Such connections may be wireless and/or wired connections.

In some examples, computing device 360 may be operatively coupled to one or more of the remote devices included in FIG. 3 using direct device communication 378. Direct device communication 378 may include communications through which computing device 360 sends and receives data directly with a remote device, using wired or wireless communication. That is, in some examples of direct device communication 378, data sent by computing device 360 may not be forwarded by one or more additional devices before being received at the remote device, and vice-versa. Examples of direct device communication 378 may include Bluetooth, Near-Field Communication, Universal Serial Bus, Wi-Fi, infrared, etc. One or more of the remote devices illustrated in FIG. 3 may be operatively coupled with computing device 360 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, computing device 360 may receive an indication of a user input (e.g., at presence-sensitive display 364 presence-sensitive display 384, presence-sensitive display 388, or presence-sensitive display 392) that corresponds to the capture action to capture content (e.g., content displayed at presence-sensitive display 364 presence-sensitive display 384, presence-sensitive display 388, or presence-sensitive display 392). Computing device 360 may, in response to receiving the indication of user input, output, for display at a display device (e.g., presence-sensitive display 364 presence-sensitive display 384, presence-sensitive display 388, or presence-sensitive display 392), a GUI element that includes indications of a plurality of actions that are associated with the captured content. Examples of such a GUI element may include one or more of: buttons, a toolbar, a menu, a list, a sheet, and the like.

Computing device 360 may receive an indication of user input that corresponds to selection of an action of the plurality of actions indicated in the GUI element. Computing device 360 may, in response to receiving the indication of user input that corresponds to selection of the action, perform the selected action.

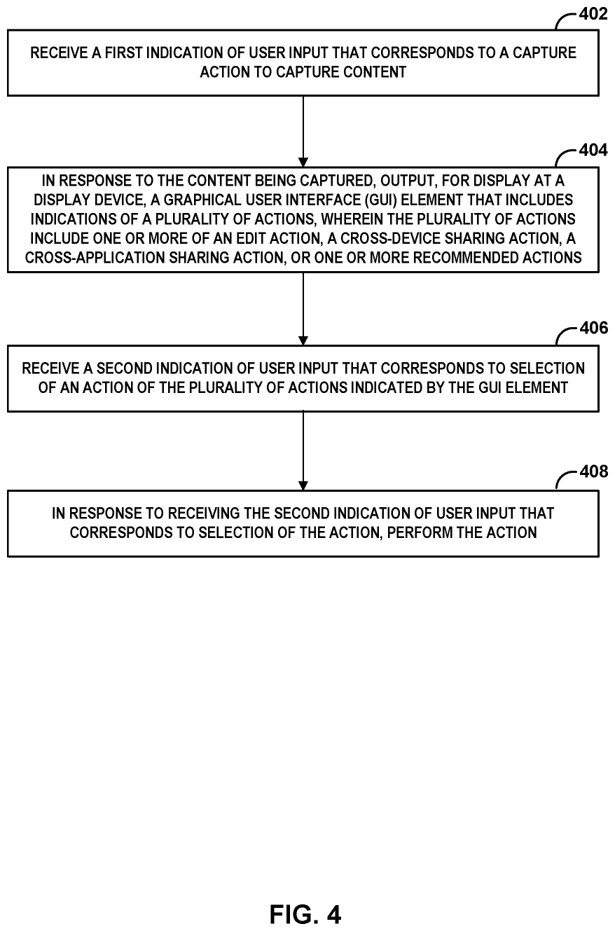

FIG. 4 is a flowchart illustrating example operations performed by an example computing device that is configured to perform notification management, in accordance with one or more aspects of the present disclosure. FIG. 4 is described below in the context of computing device 210 of FIG. 2.

As shown in FIG. 4, one or more processors 240 of computing device 210 may receive a first indication of user input (e.g., at one or more input components 242) that corresponds to a capture action to capture content (e.g., one or more output components 246) (402).

One or more processors 240 of computing device 210 may, in response to the content being captured, output, for display at a display device, a graphical user interface (GUI) element that includes indications of a plurality of actions, wherein the plurality of actions include one or more of an edit action, a cross-device sharing action, a cross-application sharing action, or one or more recommended actions, and combinations thereof (404). One or more processors 240 of computing device 210 may receive a second indication of user input that corresponds to selection of an action of the plurality of actions indicated by the GUI element (406). One or more processors 240 of computing device 210 may, in response to receiving the second indication of user input that corresponds to selection of the action, perform the action (408).

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

1. A method comprising:
receiving, by one or more processors of a computing device, a first indication of user input that corresponds to a capture action to capture content;
in response to the content being captured, outputting, by the one or more processors and for display at a display device, a graphical user interface element that includes indications of a plurality of actions, wherein the plurality of actions include one or more of an edit action, a cross-device sharing action, a cross-application sharing action, or one or more recommended actions associated with the content
receiving, by the one or more processors, a second indication of user input that corresponds to selection of an action of the plurality of actions indicated by the graphical user interface element; and
in response to receiving the second indication of user input that corresponds to selection of the action, performing, by the one or more processors, the action.

2. The method of claim 1, further comprising:
in response to the content being captured, determining, by the one or more processors and based at least in part on the content, the one or more recommended actions associated with the content.

3. The method of claim 2, wherein determining the one or more recommended actions associated with the content further comprises:
determining, by the one or more processors, that the content includes a street address; and
in response to determining that the content includes the street address, determining, by the one or more processors, that the one or more recommended actions include a mapping action that, when selected, enables the one or more processors to present a digital map of the street address included in the content.

4. The method of claim 2, wherein determining the one or more recommended actions associated with the content further comprises:
determining, by the one or more processors, that the content includes a Universal Resource Locator; and
in response to determining that the content includes the Universal Resource Locator, determining, by the one or more processors, that the one or more recommended actions include a web browsing action that, when selected, enables the one or more processors to open the Universal Resource Locator included in content in a web browser application.

5. The method of claim 1, wherein performing the action further comprises:
in response to receiving an indication of user input that corresponds to selection of the edit action, outputting, by the one or more processors for display at the display device, an editing graphical user interface that enables editing of the content.

6. The method of claim 1, wherein performing the action further comprises:
in response to receiving an indication of user input that corresponds to selection of the cross-device sharing action, outputting, by the one or more processors for display at the display device, a sharing graphical user interface that enables sharing the content with one or more other computing devices.

7. The method of claim 6, wherein outputting the sharing graphical user interface further comprises:
outputting, by the one or more processors, the sharing graphical user interface that includes indications of one or more other computing devices;
receiving, by the one or more processors, a third indication of user input that corresponds to selection of another computing device of the one or more other computing devices indicated by the sharing graphical user interface; and
in response to receiving the third indication of user input that corresponds to selection of the other computing device, sharing, by the one or more processors, the content with the other computing device.

8. The method of claim 1, wherein performing the action further comprises:
in response to receiving an indication of user input that corresponds to selection of the cross-device sharing action, determining, by the one or more processors, one or more other computing devices with which to share the content; and
sharing, by the one or more processors, the content with the one or more other computing devices.

9. The method of claim 1, wherein performing the action further comprises:
in response to receiving an indication of user input that corresponds to selection of the cross-application sharing action, determining, by the one or more processors, one or more applications with which to share the content; and
sharing, by the one or more processors, the content with the one or more applications.

10. The method of claim 1, wherein the content includes one or more of text, an image, a video, audio output, or a file.

11. The method of claim 1, wherein the capture action to capture the content comprises a screenshot action to capture a screenshot that includes the content.

12. The method of claim 1, wherein the capture action to capture the content comprises a copy action to copy the content.

13. The method of claim 1, wherein the capture action to capture the content comprises a sharing function provided by an operating system of the computing device.

14. The method of claim 1, further comprising:
receiving, by the one or more processors, a fourth indication of user input that corresponds to a second capture action to capture a second content, wherein the second capture action is of a different type of capture action than the capture action;
in response to the second content being captured, outputting, by the one or more processors and for display at the display device, a second graphical user interface element that includes indications of a second plurality of actions, wherein the second plurality of actions include one or more of the edit action, the cross-device sharing action, or the cross-application sharing action;
receiving, by the one or more processors, a fifth indication of user input that corresponds to selection of a second action of the second plurality of actions indicated by the second graphical user interface element; and
in response to receiving the fifth indication of user input that corresponds to selection of the second action, performing, by the one or more processors, the second action.

15. The method of claim 14, wherein the graphical user interface element and the second graphical user interface element are visually consistent with each other.

16. The method of claim 15, wherein the graphical user interface element and the second graphical user interface element are a same first graphical user interface element type.

17. The method of claim 16, wherein the graphical user interface element and the second graphical user interface element each indicates the edit action using a same second graphical user interface element type, wherein the graphical user interface element and the second graphical user interface element each indicates the cross-device sharing action using a same third graphical user interface element type, and wherein the graphical user interface element and the second graphical user interface element each indicates the cross-application sharing action using a same fourth graphical user interface element type.

18. The method of claim 15, wherein the graphical user interface element and the second graphical user interface element each includes indications of the edit action, the cross-device sharing action, and the cross-application sharing action in a same order.

19. A computing device comprising:
a memory; and
one or more processors configured to:
receive a first indication of user input that corresponds to a capture action to capture content;
in response to the content being captured, output, for display at a display device, a graphical user interface element that includes indications of a plurality of actions, wherein the plurality of actions include one or more of an edit action, a cross-device sharing action, a cross-application sharing action, or one or more recommended actions associated with the content;
receive a second indication of user input that corresponds to selection of an action of the plurality of actions indicated by the graphical user interface element; and
in response to receiving the second indication of user input that corresponds to selection of the action, perform the action.

20. A non-transitory computer-readable storage medium comprising instructions, that when executed by one or more processors, cause the one or more processors of a computing device to:
receive a first indication of user input that corresponds to a capture action to capture content;
in response to the content being captured, output, for display at a display device, a graphical user interface element that includes indications of a plurality of actions, wherein the plurality of actions include one or more of an edit action, a cross-device sharing action, a cross-application sharing action, or one or more recommended actions associated with the content;
receive a second indication of user input that corresponds to selection of an action of the plurality of actions indicated by the graphical user interface element; and
in response to receiving the second indication of user input that corresponds to selection of the action, perform the action.
